(19) United States
(12) Patent Application Publication
(10) Pub. No.: US 2008/0005504 A1
(43) Pub. Date: Jan. 3, 2008

(54) Global overflow method for virtualized transactional memory

(76) Inventors: Jesse Barnes, Oakland, CA (US); Ravi Rajwar, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/479,902

(22) Filed: Jun. 30, 2006

(51) Int. Cl. G06F 12/00

(52) U.S. Cl. 711/156

(57) ABSTRACT

A method and apparatus for virtualizing and/or extending transactional memory is described herein. Transactions are executed using local shared transactional memory, such as a cache memory. Upon overflowing the shared transactional memory, the transactional memory is virtualized and/or extended into a higher-level memory, such as a system memory. Upon an overflow event, such as an eviction of a cache line previously accessed during a currently pending transaction, an overflow flag is set to notify processors/cores that the transactional memory is to be virtualized in a global overflow table. A base address of the global overflow table is also potentially stored to reference the base of the global overflow table in the higher-level memory.

### FIELD

This invention relates to the field of processor execution and, in particular, to executing groups of operations.

### BACKGROUND

Advances in semi-conductor processing and logic design have permitted an increase in the amount of logic that may be present on integrated circuit devices. As a result, computer system configurations have evolved from a single or multiple integrated circuits in a system to multiple cores and multiple logical processors present on individual integrated circuits. A processor or integrated circuit typically comprises a single processor die, where the processor die may include any number of cores or logical processors.

As an example, a single integrated circuit may have one or multiple cores. The term core usually refers to the ability of logic on an integrated circuit to maintain an independent architecture state, where each independent architecture state is associated with at least some dedicated execution resources. As another example, a single integrated circuit or a single core may have multiple hardware threads for executing multiple software threads, which is also referred to as a multi-threading integrated circuit or a multi-threading core. Multiple hardware threads usually share common data caches, instruction caches, execution units, branch predictors, control logic, bus interfaces, and other processor resources, while maintaining a unique architecture state for each logical processor.

The ever increasing number of cores and logical processors on integrated circuits enables more software threads to be executed. However, the increase in the number of software threads that may be executed simultaneously has created problems with synchronizing data shared among the software threads. One common solution to accessing shared data in multiple core or multiple logical processor systems comprises the use of locks to guarantee mutual exclusion across multiple accesses to shared data. However, the ever increasing ability to execute multiple software threads potentially results in false contention and a serialization of execution.

Another data synchronization technique includes the use of transactional memory (TM). Often transactional execution includes speculatively executing a grouping of a plurality of micro-operations, operations, or instructions. However, in previous hardware TM systems, if a transaction becomes too large for, i.e. overflows, a memory, then the transaction is usually restarted. Here, the time taken to execute the transaction up to the overflow is potentially squandered.

### BRIEF DESCRIPTION OF THE DRAWINGS

The present invention is illustrated by way of example and not intended to be limited by the figures of the accompanying drawings.

FIG. 1 illustrates an embodiment of a multi-core processor capable of extending transactional memory.

FIG. 2a illustrates an embodiment of a multi-core processor including a register for each core to store an overflow flag.

FIG. 2b illustrates another embodiment of a multi-core processor including a global register to store an overflow flag.

FIG. 3 illustrates an embodiment of a multi-core processor including a base address register for each core to store a base address of an overflow table.

FIG. 4a illustrates an embodiment of an overflow table.

FIG. 4b illustrates another embodiment of an overflow table.

FIG. 5 illustrates another embodiment of an overflow table including a plurality of pages.

FIG. 6 illustrates an embodiment of a system to virtualize transactional memory.

FIG. 7 illustrates an embodiment of a flow diagram for virtualizing transactional memory.

FIG. 8 illustrates another embodiment of a flow diagram for virtualizing transactional memory.

### DETAILED DESCRIPTION

In the following description, numerous specific details are set forth such as examples of specific hardware support for transactional execution, specific types of local/memory in processors, and specific types of memory accesses and locations, etc. in order to provide a thorough understanding of the present invention. It will be apparent, however, to one skilled in the art that these specific details need not be employed to practice the present invention. In other instances, well known components or methods, such as coding of transactions in software, demarcation of transactions, specific multi-core and multi-threaded processor architectures, interrupt generation/handling, cache organizations, and specific operational details of microprocessors, have not been described in detail in order to avoid unnecessarily obscuring the present invention.

The method and apparatus described herein are for extending and/or virtualizing transactional memory (TM) to support overflow of local memory during execution of transactions. Specifically, virtualizing and/or extending transactional memory is primarily discussed in reference to multi-core processor computer systems. However, the methods and apparatus for extending/virtualizing transactional memory are not so limited, as they may be implemented on or in association with any integrated circuit device or system, such as cell phones, personal digital assistants, embedded controllers, mobile platforms, desktop platforms, and server platforms, as well as in conjunction with other resources, such as hardware/software threads, that utilize transactional memory.

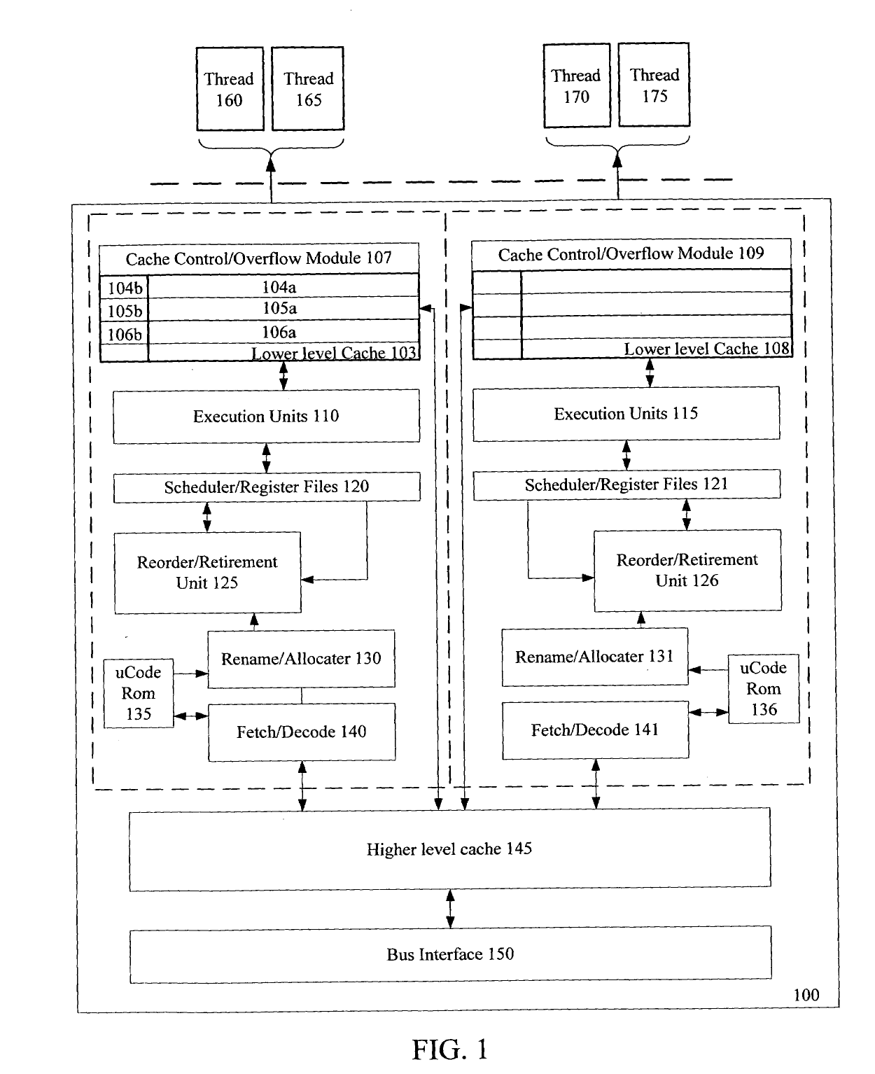

Referring to FIG. 1, an embodiment of multi-core processor 100, which is capable of extending transactional memory, is illustrated. Transactional execution usually includes grouping a plurality of instructions or operations into a transaction, atomic section of code, or a critical section of code. In some cases, use of the word instruction refers to a macro-instruction which is made up of a plurality of operations. There are commonly two ways to identify transactions. The first example includes demarcating the transaction in software. Here, some software demarcation is included in code to identify a transaction. In another embodiment, which may be implemented in conjunction with the foregoing software demarcation, transactions are grouped by hardware or recognized by instructions indicating a beginning of a transaction and an end of a transaction.

In a processor, a transaction is either executed speculatively or non-speculatively. In the second case, a grouping of instructions is executed with some form of lock or guaranteed valid access to memory locations to be accessed. In the alternative, speculative execution of a transaction is more common, where a transaction is speculatively executed and committed upon the end of the transaction. A pendency of a transaction, as used herein, refers to a transaction that has begun execution and has not been committed or aborted, i.e. pending.

Typically, during speculative execution of a transaction, updates to memory are not made globally visible until the transaction is committed. While the transaction is still pending, locations loaded from and written to within a memory are tracked. Upon successful validation of those memory locations, the transaction is committed and updates made during the transaction are made globally visible. However, if the transaction is invalidated during its pendency, the transaction is restarted without making the updates globally visible.

In the embodiment illustrated, processor 100 includes two cores, cores 101 and 102; although, any number of cores may be present. A core often refers to any logic located on an integrated circuit capable to maintain an independent architectural state, wherein each independently maintained architectural state is associated with at least some dedicated execution resources. For example, in FIG. 1, core 101 includes execution units 110, while core 102 includes execution units 115. Even though execution units 110 and 115 are depicted as logically separate, they may physically be arranged as part of the same unit or in close proximity. However, as an example, scheduler 120 is not able to schedule execution for core 101 on execution units 115.

In contrast to cores, a hardware thread typically refers to any logic located on an integrated circuit capable to maintain an independent architectural state, wherein the independently maintained architectural states share access to execution resources. As can be seen, as certain processing resources are shared and others are dedicated to an architectural state, the line between the nomenclature of a hardware thread and core overlaps. Yet often, a core and a hardware thread are viewed by an operating system as individual logical processors, with each logical processor being capable of executing a thread. Therefore, a processor, such as processor 100, is capable of executing multiple threads, such as thread 160, 165, 170, and 175. Although each core, such as core 101, is illustrated as capable of executing multiple software threads, such as thread 160 and 165, a core is potentially also only capable of executing a single thread.

In one embodiment, processor 100 includes symmetric cores 101 and 102. Here, core 101 and core 102 are similar cores with similar components and architecture. Alternatively, core 101 and 102 may be asymmetric cores with different components and configurations. Yet, as cores 101 and 102 are depicted as symmetric cores, the functional blocks in core 101 will be discussed, to avoid duplicate discussion in regards to core 102. Note that the functional blocks illustrated are logical functional blocks, which may include logic that is shared between, or overlap boundaries of, other functional blocks. In addition, each of the functional blocks are not required and are potentially interconnected in different configurations. For example, fetch and decode block 140 may include a fetch and/or pre-fetch unit, a decode unit coupled to the fetch unit, and an instruction cache coupled before the fetch unit, after the decode unit, or to both the fetch and decode units.

In one embodiment, processor 100 includes a bus interface unit 150 for communicating with external devices and a higher level cache 145, such as a second-level cache, that is shared between core 101 and 102. In an alternative embodiment, core 101 and 102 each include separate second-level caches.

Fetch, decode, and branch prediction unit 140 is coupled to second level cache 145. In one example, core 101 includes a fetch unit to fetch instructions, a decode unit to decode the fetched instructions, and an instruction cache or trace cache to store fetched instructions, decoded instructions, or a combination of fetched and decoded instructions. In another embodiment, fetch and decode block 140 includes a pre-fetcher having a branch predictor and/or a branch target buffer. In addition, a read only memory, such as microcode ROM 135, is potentially used to store longer or more complex decoded instructions.

In one example, allocator and renamer block 130 includes an allocator to reserve resources, such as register files to store instruction processing results. However, core 101 is potentially capable of out-of-order execution, where allocator and renamer block 130 also reserves other resources, such as a reorder buffer to track instructions. Block 130 may also include a register renamer to rename program/instruction reference registers to other registers internal to core 101. Reorder/retirement unit 125 includes components, such as the reorder buffers mentioned above, to support out-of-order execution and later retirement of instructions executed out-of-order. As an example, micro-operations loaded in a reorder buffer are executed out-of-order by execution units and then pulled out of the reorder buffer, i.e. retired, in the same order the micro-operations entered the re-order buffer.

Scheduler and register files block 120, in one embodiment, includes a scheduler unit to schedule instructions on execution units 110. In fact, instructions are potentially scheduled on execution units 110 according to their type and execution units 110's availability. For example, a floating point instruction is scheduled on a port of execution units 110 that has an available floating point execution unit. Register files associated with execution units 110 are also included to store information instruction processing results. Exemplary execution units available in core 101 include a floating point execution unit, an integer execution unit, a jump execution unit, a load execution unit, a store execution unit, and other known execution units. In one embodiment, execution units 110 also include a reservation station and/or address generation units.

In the embodiment illustrated, lower-level cache 103 is utilized as transactional memory. Specifically, lower level cache 103 is a first level cache to store recently used/operated on elements, such as data operands. Cache 103 includes cache lines, such as lines 104, 105, and 106, which may also be referred to as memory locations or blocks within cache 103. In one embodiment, cache 103 is organized as a set associative cache; however, cache 103 may be organized as a fully associative, a set associative, a direct mapped, or other known cache organization.

As illustrated, lines 104, 105, and 106 includes portions or fields, such as portion 104a and field 104b. In one embodiment, lines, locations, blocks or words, such as portions 104a, 105a, and 106a of lines 104, 105, and 106 are capable of storing multiple elements. An element refers to any instruction, operand, data operand, variable, or other grouping of logical values that is commonly stored in memory. As an example, cache line 104 stores four elements in portion 104a including an instruction and three operands. The elements stored in cache line 104a may be in a packed or compressed state, as well as an uncompressed state. Moreover, elements are potentially stored in cache 103 unaligned with boundaries of lines, sets, or ways of cache 103. Memory 103 will be discussed in more detail in reference to the exemplary embodiments below.

Cache 103, as well as other features and devices in processor 100, store and/or operate on logic values. Often, the use of logic levels, logic values, or logical values is also referred to as 1's and 0's, which simply represents binary logic states. For example, a 1 refers to a high logic level and 0 refers to a low logic level. Other representations of values in computer systems have been used, such as decimal and hexadecimal representation of logical values or binary values. For example, take the decimal number 10, which is represented in binary values as 1010 and in hexadecimal as the letter A.

In the embodiment illustrated in FIG. 1, accesses to lines 104, 105, and 106 are tracked to support transactional execution. Access tracking fields, such as fields 104b, 105b, and 106b are utilized to track accesses to their corresponding memory lines. For example, memory line/portion 104a is associated with corresponding tracking field 104b. Here, access tracking field 104b is associated with and corresponds to cache line 104a, as tracking field 104b includes bits that are part of cache line 104. Association may be through physical placement, as illustrated, or other association, such as relating or mapping access tracking field 104b with an address referencing memory line 104a or 104b in a hardware or software lookup table. In fact, a transaction access field is implemented in hardware, software, firmware or any combination thereof.

Therefore, upon an access to line 104a during execution of a transaction, access tracking field 104b tracks the access. Accesses include operations, such as reads, writes, stores, loads, evictions, snoops, or other known accesses to memory locations.

As a simplified illustrative example, assume access tracking fields 104b, 105b, and 105b include two transaction bits: a first read tracking bit and a second write tracking bit. In a default state, i.e. a first logical value, the first and second bits in access tracking fields 104b, 105b, and 105b represent that cache lines 104, 105, and 106, respectively, have not been accessed during execution of a transaction, i.e. during a pendency of a transaction. Upon a load operation from cache line 104a, or a system memory location associated with cache line 104a resulting in a load from line 104a, the first read tracking bit in access field 104b is set to a second state/value, such as a second logical value, to represent a read from cache line 104 has occurred during execution of the transaction. Similarly, upon a write to cache line 105a, the second write tracking bit in access field 105b is set to the second state to represent a write to cache line 105 occurred during execution of the transaction.

Consequently, if the transaction bits in field 104a associated with line 104a are checked, and the transaction bits represent the default state, then cache line 104 has not been accessed during a pendency of the transaction. Inversely, if the first read tracking bit represents the second value, then cache line 104 has been previously accessed during pendency of the transaction. More specifically, a load from line 104a occurred during execution of the transaction, as represented by the first read tracking bit in access field 104b being set.

Access fields 104b, 105b, and 105b potentially have other uses during transactional execution as well. For example, validation of a transaction is traditionally done in two manners. First, if an invalid access, which would cause the transaction to abort, is tracked, then at the time of the invalid access the transaction is aborted and potentially restarted. Alternatively, validation of the lines/locations accessed during execution of the transaction is done at the end of the transaction before commitment. At that time, the transaction is committed, if the validation was successful, or aborted if the validation was not successful. In either of the scenarios, access tracking fields 104b, 105b, and 105b are useful, as they identify which lines have been accessed during execution of a transaction.

As another simplified illustrative example, assume a first transaction is executing, and during execution of the first transaction a load from line 105a occurred. As a result, corresponding access tracking field 105b indicates an access to line 105 occurred during execution of the transaction. If a second transaction causes a conflict in regards to line 1050, then either the first or second transaction may be immediately aborted based on the access to line 105 by the second transaction, since access tracking field 105b represented that line 105 was loaded from by the first pending transaction.

In one embodiment, upon the second transaction causing a conflict in regards to line 105 with corresponding field 105b indicating a previous access by the first pending transaction, an interrupt is generated. That interrupt is handled by a default handler and/or an abort handler that initiates an abort of either the first or second transaction, as a conflict occurred between two pending transactions.

Upon an abort or commitment of the transaction, the transaction bits that were set during execution of the transaction are cleared to ensure the states of the transaction bits are reset to the default state for later tracking of accesses during subsequent transactions. In another embodiment, access tracking fields may also store a resource ID, such as a core ID or thread ID, as well as a transaction ID.

As referred to above and immediately below in reference to FIG. 1, lower level cache 103 is utilized as transactional memory. However, transactional memory is not so limited. In fact, higher level cache 145 is potentially used as transactional memory. Here, accesses to lines of cache 145 are tracked. As mentioned, an identifier, such as a thread ID or transaction ID is potentially used in a higher level memory, such as cache 145, to track which transaction, thread, or resource performed the access being tracked in cache 145.

As yet another example of potential transactional memory, a plurality of registers associated with a processing element or resource as execution space or scratch pad to store variables, instructions, or data are used as transactional memory. In this example, memory locations 104, 105, and 106 are a grouping of registers including registers 104, 105, and 106. Other examples of transactional memory include a cache, a plurality of registers, a register file, a static random access memory (SRAM), a plurality of latches, or other storage elements. Note that processor 100 or any processing resources on processor 100 may be addressing a system memory location, a virtual memory address, a physical address, or other address when reading from or writing to a memory location.

As long as a transaction does not overflow transactional memory, such as lower level cache 103, conflicts between transactions are detected by operation of access fields 104b, 105b, and 105b tracking accesses to corresponding lines 104, 105, and 105, respectively. As stated above, transactions may be validated, committed, invalidated, and/or aborted using access tracking fields 104b, 105b, and 105b. However, when a transaction overflows memory 103, overflow module 107 is to support virtualization and/or extension of transactional memory 103, i.e. to store a state of the transaction to a second memory, in response to an overflow event. Therefore, instead of aborting the transaction upon an overflow of memory 103, which results in a loss of the execution time associated with executing the prior operations in the transaction, the transaction state is virtualized to continue execution.

An overflow event may include any actual overflow of memory 103 or any prediction of an overflow of memory 103. In one embodiment, an overflow event is selecting for eviction, or actual eviction of, a line in memory 103 that was previously accessed during execution of a currently pending transaction. In other words, an operation is overflowing memory 103 in that memory 103 is full with memory lines that have been accessed by currently pending transactions. As a result, memory 103 is selecting a line associated with a pending transaction to be evicted. Essentially, memory 103 is full and attempts to create room by evicting lines associated with transactions that are still pending. Known or otherwise available techniques may be used for cache replacement, eviction of lines, commitment, access tracking, transaction conflict checking, and transaction validation.

However, an overflow event may not be limited to an actual overflow of memory 103. For example, a prediction that a transaction is too large for memory 103 may constitute an overflow event. Here, an algorithm or other prediction method is used to determine the size of a transaction and creates an overflow event before memory 103 is actually overflowed. In another embodiment, an overflow event is the start of a nested transaction. As nested transactions are more complex and traditionally take more memory to support, detection of a first-level nested transaction or subsequent-level nested transaction may result in an overflow event.

In one embodiment, overflow logic 107 includes an overflow storage element, such as a register, to store an overflow bit and a base address storage element. Although overflow logic 107 is illustrated in the same functional block as cache control logic, the overflow register to store the overflow bit and the base address register are potentially present anywhere in microprocessor 100. As an example, each core on processor 100 includes an overflow register to store a representation of a base address for a global overflow table and the overflow bit. However, the implementation of the overflow bit and base address are not so limited. In fact, a global register visible to all cores or threads on processor 100 may include the overflow bit and the base address. Alternatively, each core or hardware thread includes a base address register and a global register includes the overflow bit. As can be seen, any number of configurations may be implemented to store an overflow bit and a base address for an overflow table.

The overflow bit is set based on the overflow event. Continuing the embodiment from above, where selecting a line in memory 103 for eviction that has been previously accessed during execution of a pending transaction constitutes an overflow event, the overflow bit is set based on the selection of a line in memory 103 for eviction, which has been previously accessed during execution of a pending transaction.

In one embodiment, the overflow bit is set using hardware, such as logic to set the overflow bit, when a line, such as line 104, is selected for eviction and had previously been accessed during a pending transaction. For example, cache controller 107 selects line 104 for eviction based on any number of known or otherwise available cache replacement algorithms. In fact, the cache replacement algorithm may be biased against replacing cache lines, such as line 104, which has been previously accessed during execution of a pending transaction. Nevertheless, upon the selecting line 104 for eviction, the cache controller or other logic checks access tracking field 104b. Logic determines, based on the values in field 104b, if cache line 104 has been accessed during execution of a pending transaction, as discussed above. If cache line 104 has been previously accessed during a pending transaction, logic in processor 100 sets the global overflow bit.

In another embodiment, software or firmware sets the global overflow bit. In a similar scenario, upon determining line 104 was previously accessed during a pending transaction, an interrupt is generated. That interrupt is handled by a user-handler and/or an abort handler executed in execution units 110, which sets the global overflow bit. Note that if the global overflow bit is currently set, the hardware and/or software does not have to set the bit again, as memory 103 has already overflowed.

As an illustrative example of uses for the overflow bit, once the overflow bit is set, hardware and/or software tracks accesses to cache lines 104, 105, and 106, validates transactions, checks for conflicts, and performs other transaction related operations typically associated with memory 103 and access fields 104b, 105b, and 106b utilizing an extended transactional memory.

The base address is used to identify the base address of the virtualized transactional memory. In one embodiment, the virtualized transactional memory is stored in a second memory device, which is larger than memory 103, such as higher level cache 145 or a system memory device associated with process or 100. As a result, the second memory is capable of handling a transaction that has overflowed memory 103.

In one embodiment, the extended transactional memory is referred to as a global overflow table to store the state of the transaction. Hence, the base address represents a base address of the global overflow table, which is to store a state of a transaction. The global overflow table is similar in operation to memory 103 in reference to access tracking fields 104b, 105b, and 106b. As an illustrative example, assume line 106 is selected for eviction. However, access field 106b represents that line 106 has been previously accessed during execution of a pending transaction. As stated above, the global overflow bit is set, based on the overflow event, if the global overflow bit is not already currently set.

If the global overflow table has not been setup, an amount of the second memory is allocated for the table. As an example, a page fault is generated indicating an initial page of the overflow table has not been allocated. An operating system, then allocates a range of the second memory to the global overflow table. The range of the second memory may be referred to as a page of the global overflow table. A representation of a base address of the global overflow table is then stored-in processor 100.

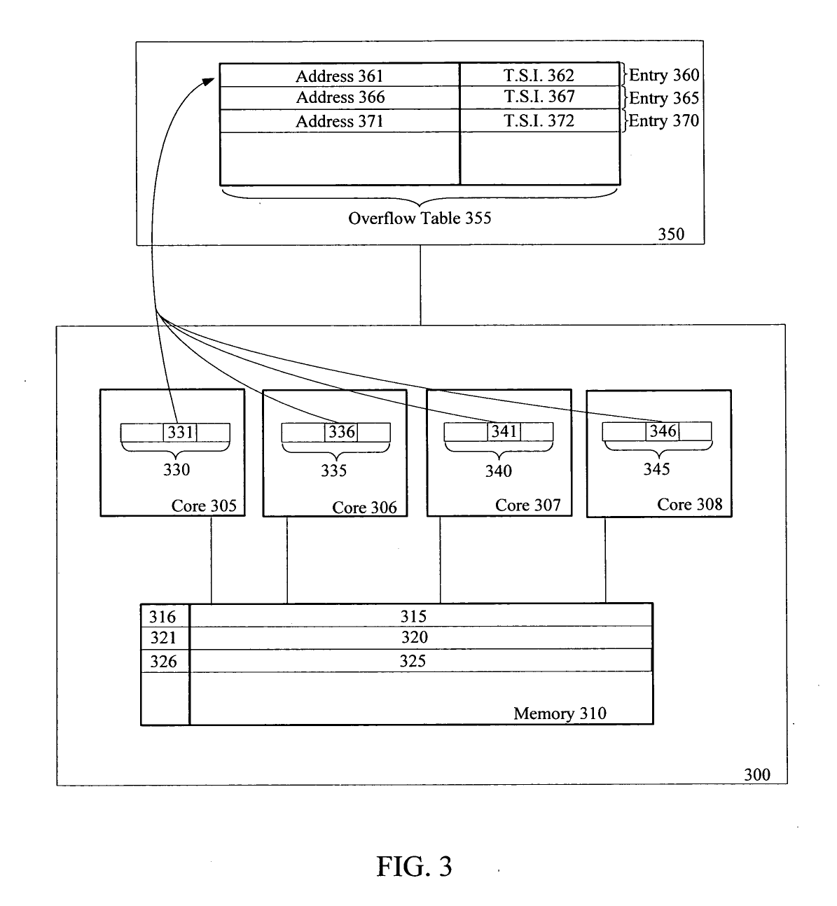

Before evicting line 106, the state of the transaction is stored in the global overflow table. In one embodiment, storing the state of a transaction includes storing an entry in the global overflow table corresponding to the operation and/or line 106, which is associated with the overflow event. The entry may include any combination of an address, such as a physical address, associated with line 106, a state of access tracking field 106b, a data element associated with line 106, a size of line 106, an operating system control field, and/or other fields. A global overflow table and a second memory are discussed in more detail below in reference to FIGS. 3-5.

Consequently, when an instruction or operation as part of a transaction is passes through the pipeline of processor 100, accesses to transactional memory, such as cache 103 are tracked. Furthermore, when a transactional memory is full, i.e. it overflows, the transactional memory is extended into other memory either on processor 100 or associated with/coupled to processor 100. Additionally, registers through out processor 100 potentially store an overflow flag to represent that a transactional memory is overflowed and a base address to identify a base address of the extended transactional memory.

Although, transactional memory has been specifically discussed in reference to an exemplary multi-core architecture shown in FIG. 1, extension and/or virtualization of transactional memory may be implemented in any processing system for executing instructions/operating on data. As an example, an embedded processor capable of executing multiple transactions in parallel potentially implements virtualized transactional memory.

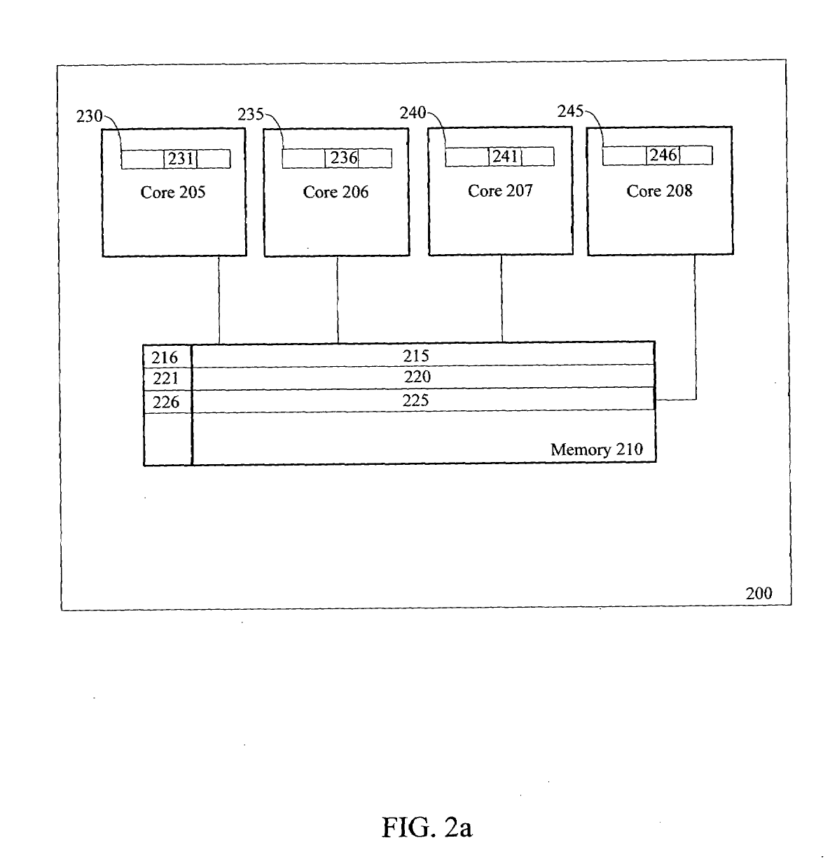

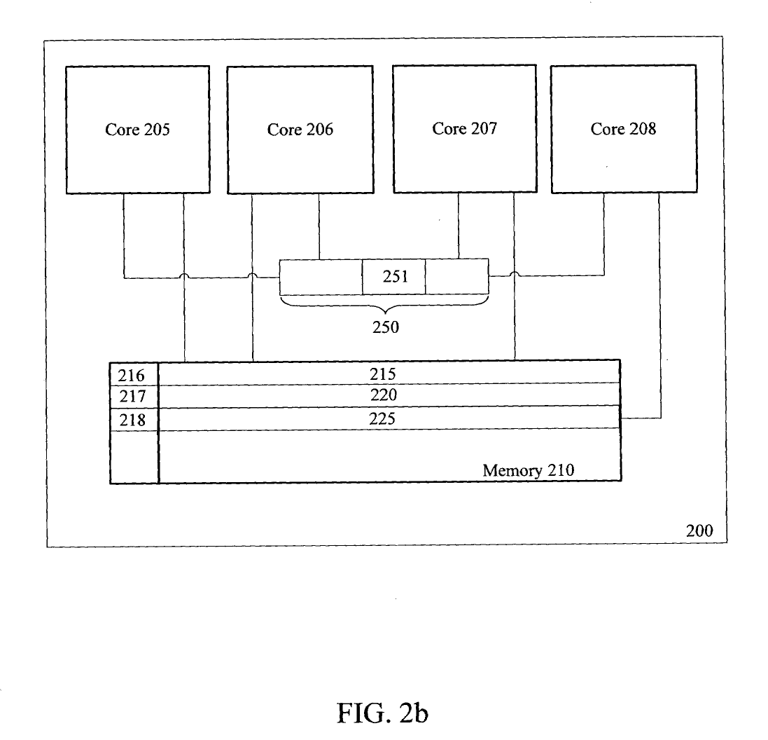

Turning to FIG. 2a an embodiment of multi-core processor 200 is illustrated. Here, processor 200 includes four cores, core 205-208, but any other number of cores may be used. In one embodiment, memory 210 is a cache memory. Here, memory 210 is illustrated outside the functional boxes of cores 205-208. In one embodiment, memory 210 is a shared cache, such as a second level or other higher level cache. However, in one embodiment, functional blocks 205-208 represent the architecture state of cores 205-208 and memory 210 is a first level or lower level cache assigned/associated with one of the cores, such as core 205, or cores 205-208. Therefore, memory 210 as illustrated may be a lower-level cache within a core, such as memory 103 illustrated in FIG. 1, a higher level cache, such as cache 145 illustrated in FIG. 1, or other storage element, such as the example of a collection of registers discussed above.

Each core includes a register, such as registers 230, 235, 240, and 245. In one embodiment, registers 230, 235, 240, and 245 are machine specific registers (MSRs). Yet, registers 230, 235, 240, and 245 may be any registers in processors 200, such as a register that is part of each core's set of architecture state registers.

Each of the registers includes a transaction overflow flag: flags 231, 236, 241, and 246. As stated above, upon an overflow event, a transaction overflow flag is set. Overflow flags are set through hardware, software, firmware, or any combination thereof. In one embodiment an overflow flag is a bit, which potentially has two logical states. However, an overflow flag may be any number of bits or other representation of state to identify when a memory has overflowed.

For example, if an operation as part of a transaction executing on core 205 overflows cache 210, then hardware, such as logic, or software, such as user handler invoked to handle an overflow interrupt, sets flag 231. In a first logical state, which is a default state, core 205 executes transactions using memory 210. Normal eviction, access tracking, conflict checks, and validation are done using cache 210, which includes blocks 215, 220, and 225, as well as corresponding fields 216, 221, and 226. However, when flag 231 is set to a second state, cache 210 is extended. Based on one flag, such as flag 231 being set, the rest of flags 236, 241, and 246 may also be set.

For example, protocol messages sent between cores 205-208 set the other flags, based on one overflow bit being set. As an example, assume overflow flag 231 is set based on an overflow event that occurred in memory 210, which in this example, is a first level data cache in core 205. In one embodiment, after setting flag 231, a broadcast message is sent on a-bus interconnection cores 205-208 to set flags 236, 241, and 246. In another embodiment, where cores 205-208 are connected in a point-to-point, ring, or other format, a message from core 205 is sent to each core or forwarded from core to core to set flags 236, 241, and 246. Note that similar messaging etc. may be done in a multiprocessor format to ensure flags are set between multiple physical processors, as discussed below. When the flags in cores 205-208 are set, subsequent transactional execution is informed to check virtual/extended memory for access tracking, conflict checking, and/or validation.

The previous discussion included a single physical processor 200 including multiple cores. However, similar configurations, protocols, hardware, and software are used when cores 205-208 are separate physical processors within a system. In this instance, each processor has an overflow register, such as registers 230, 235, 240, and 245 with their respective overflow flags. Upon setting one overflow flag, the rest may also be set through similar manner of protocol communication on interconnects between the processors. Here, an exchange of communication on a broadcasting bus or point-to-point interconnect communicates the value of an overflow flag being set to a value representing an overflow event occurred.

Referring next to FIG. 2b, another embodiment of a multi-core processor having an overflow flag is illustrated. In contrast to FIG. 2a, instead of each core 205-208 including an overflow register and overflow flag, a single overflow register 250 and overflow flag 251 is present in processor 200. Consequently, upon an overflow event, flag 251 is set and is globally visible to each of cores 205-208. Therefore, if flag 251 is set, then access tracking, validation, conflict checking, and other transactional execution operations are performed using a global overflow table.

As an illustrative example, assume that memory 210 has overflowed during execution of a transaction, and as a result, overflow bit 251 in register 250 is set. In addition, subsequent operations have been tracked using virtualized transactional memory. If only memory 210 is checked for conflicts or used for validation before committing a transaction, then conflicts/accesses tracked by the overflow memory will not be discovered. However, if conflict checking and validation are done utilizing the overflow memory, then the conflicts may be detected and the transaction aborted, instead of committing a conflicted transaction.

As stated above, upon setting an overflow flag that is not currently set, space for a global overflow table is requested/allocated, if space is not already allocated. Conversely, when a transaction is committed or aborted, entries in a global overflow table corresponding to the transaction are freed. In one embodiment, freeing an entry includes clearing an access tracking state or other field in the entry. In another embodiment, freeing an entry includes deleting the entry from the global overflow table. When the last entry in an overflow table is freed, the global overflow bit is cleared back to the default state. Essentially, freeing the last entry in a global overflow table represents that any pending transactions fit in cache 210, and overflow memory is not currently utilized for transactional execution. FIGS. 3-5 discuss overflow memory, and specifically global overflow tables, in more detail.

In turning to FIG. 3, an embodiment of a processor including multiple cores coupled to a higher-level memory is illustrated. Memory 310 includes lines 315, 320, and 325. Access tracking fields 316, 321, and 326 correspond to lines 315, 320, and 325, respectively. Each of the access fields is to track accesses to their corresponding line in memory 310. Processor 300 also includes cores 305-308. Note that memory 310 may be a low-level cache within any core of cores 305-308, a higher level cache shared by cores 305-308, or any other known or otherwise available memory in a processor to be utilized as transactional memory. Each core includes a register to store a base address of a global overflow table, such as registers 330, 335, 340, and 345. When executing a transaction using memory 310, base addresses 331, 336, 341, and 346 may not store a base address of a global overflow table, as the global overflow table is potentially not allocated.

However, upon overflowing memory 310, overflow table 355 is allocated. In one embodiment, an interrupt or page fault is generated based on an operation that overflows memory 310, when an overflow table 355 is not yet allocated. A user handler or kernel-level software allocates a range of higher-level memory 350 to overflow table 355 based on the interrupt or page fault. As another example, a global overflow table is allocated based on an overflow flag being set. Here, when the overflow flag is set, a write to a global overflow table is attempted. If the write fails, then a new page in the global overflow table is allocated.

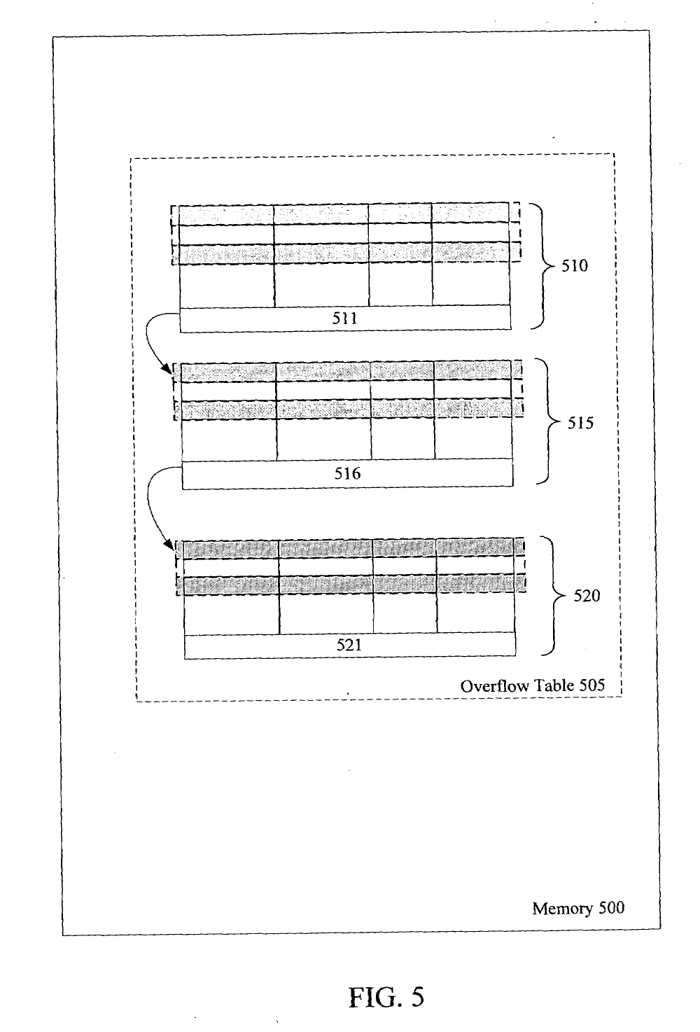

Higher-level memory 350 may be a higher level cache, a memory associated only with processor 300, a system memory shared by a system including processor 300, or any other memory at a higher-level than memory 310. The first range of memory 350 allocated to overflow table 355 is referred to as a first page of overflow table 355. A multiple page overflow table is discussed in more detail in reference to FIG. 5.

Either upon allocation of space to overflow table 355, or after allocation of memory to overflow table 355, a base address of overflow table 355 is written to registers 330, 335, 340, and/or 345. In one embodiment, kernel-level code writes the base address of the global overflow table into each one of the base address registers, 330, 335, 340, and 345. Alternatively, hardware, software, or firmware writes the base address to one of base address registers 330, 335, 340, or 345, and that base address is promulgated to the rest of the base address registers through messaging protocols between cores 305-308.

As illustrated, overflow table 355 includes entries 360, 365, and 370. Entries 360, 365, and 370 include address fields 361, 366, and 371, as well as transaction state information (T.S.I.) fields 362, 367, and 372. As an extremely simplified example of the operation of overflow table 355, assume operations from a first transaction have accessed lines 315, 320, and 325 as represented by the state of corresponding access fields 316, 321, and 326. During the pendency of the first transaction, line 315 is selected for eviction. Since the state of access tracking field 316 represents that line 315 was previously accessed during the first transaction, which is still pending, an overflow event occurred. As stated above, an overflow flag/bit is potentially set. In addition, a page within memory 350 is allocated to overflow table 355, if there is no page allocated or an additional page is required.

If no page allocation is required, the current base address of the global overflow table is stored by registers 330, 335, 340, or 345. Alternatively, upon initial allocation, a base address of overflow table 355 is written/promulgated to registers 330, 335, 340, or 345. Based on the overflow event, entry 360 is written to overflow table 355. Entry 360 includes address field 361 to store a representation of an address associated with line 315.

In one embodiment, the address associated with line 315 is a physical address of a location of an element stored in line 315. For example, the physical address is a representation of the physical address of the location in a host storage device, such as a system memory, where the element is stored. By storing physical addresses in overflow table 355, the overflow table potentially detects conflicts between all accesses by cores 305-308.

In contrast, when virtual memory addresses are stored in address fields 361, 366, and 367, processors or cores with different virtual memory base addresses and offsets have different logical views of memory. As a result, an access to the same physical memory location may not be detected as a conflict, as the physical memory location's virtual memory address is potentially viewed differently between cores. However, if virtual address memory locations are stored in overflow table 355 in combination with a context identifier in an OS control field, global conflicts are potentially discoverable.

Other embodiments of representations of addresses associated with line 315 include portions of or entire virtual memory addresses, cache line addresses, or other physical addresses. A representation of an address includes a decimal, a hexadecimal, a binary, a hash value, or other representation/manipulation of all or any portion of an address. In one embodiment, a tag value, which is a portion of the address, is a representation of an address.

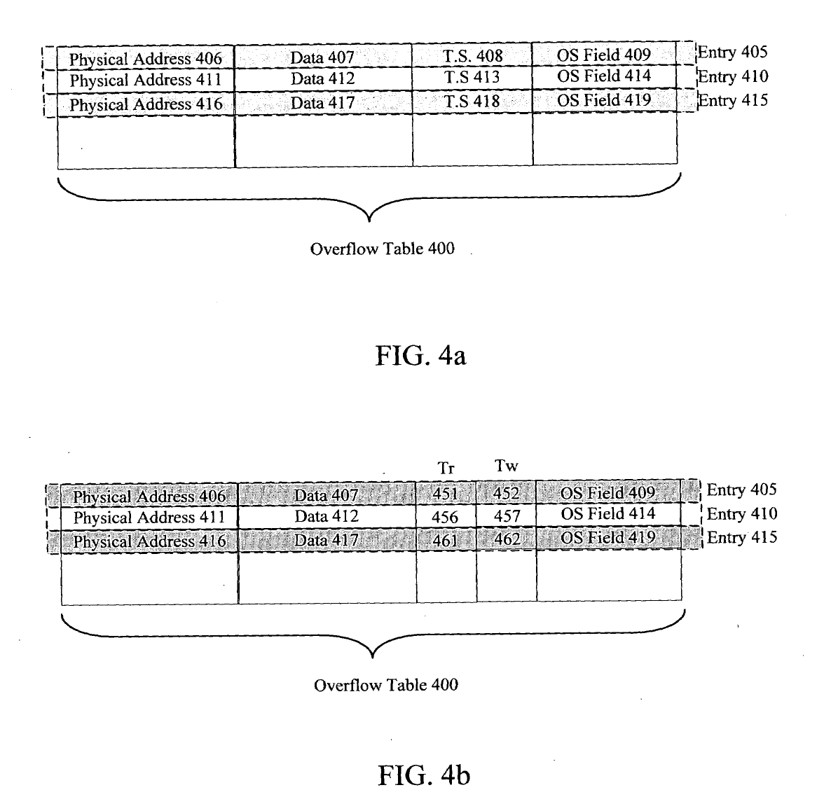

In addition to address field 361, entry 360 includes transaction state information 362. In one embodiment, T.S.I. field 362 is to store the state of access tracking field 316. For example, if access tracking field 316 includes two bits, a transaction write bit and a transaction read bit, to track writes and reads, respectively, to line 315, then the logical state of the transaction write bit and the transaction read bit is stored to T.S.I. field 362. However, any transaction related information may be stored in T.S.I. 362. Overflow table 355 and other fields potentially stored in overflow table 355 is discussed in reference to FIGS. 4a-4b.

FIG. 4a illustrates an embodiment of a global overflow table. Global overflow table 400 includes entries 405, 410, and 415 that correspond to operations that have overflowed a memory during execution of a transaction. As an example, an operation within an executing transaction overflows a memory. Entry 405 is written to global overflow table 400. Entry 405 includes physical address field 406. In one embodiment physical address field 406 is to store a physical address associated with a line in memory that is referenced by the operation that is overflowing the memory.

As an illustrative example, assume a first operation being executed as part of a transaction references a system memory location with physical address ABCD. Based on the operation, a cache controller selects a cache line mapped by a portion, ABC, of the physical address to the cache line for eviction resulting in an overflow event. Note that mapping of ABC may also include a translation to a virtual memory address associated with address ABC. Since an overflow event occurred, entry 405, which is associated with the operation and/or the cache line, is written to overflow table 400. In this example, entry 405 includes a representation of physical address ABCD in physical address field 406. Since many cache organizations, such as direct mapped and set associative organizations, map multiple system memory locations to a single cache line or set of cache lines, the cache line address potentially references a plurality of system memory locations, such as ABCA, ABCB, ABCC, ABCE, etc. Consequently, by storing the physical address ABCD or some representation thereof in physical address 406 transaction conflicts are potentially easier to detect.

In addition to physical address field 406, other fields include data field 407, transaction state field 408, and operating system control field 409. Data field 407 is to store an element, such as instruction, operand, data, or other logical information associated with an operation that overflows a memory. Note that each memory line is potentially capable of storing multiple data elements, instructions, or other logical information. In one embodiment, data field 407 is to store the data element or elements in a memory line that is to be evicted. Here, data field 407 may be optionally used. For example, upon an overflow event, an element is not stored in entry 405, unless the memory line to be evicted is in a modified state, or other cache coherency state. In addition, to instructions, operands, data elements, and other logical information, data field 407 may also includes other information, such as the size of the memory line.

Transaction state field 408 is to store transaction state information associated with an operation overflowing a transactional memory. In one embodiment, additional bits of a cache line are an access tracking field for storing transaction state information relating to accesses of the cache line. Here, the logical state of the additional bits are stored in transaction state field 408. Essentially, the memory line being evicted is virtualized and stored in a higher level memory along with a physical address and transaction state information.

Furthermore, entry 405 includes operating system control field 409. In one embodiment, OS control field 409 is to track execution context. For example, OS control field 409 is a 64-bit field to store a representation of a context ID to track the execution context associated with entry 405. Multiple entries, such as entries 410 and 415 include similar fields, such as physical address fields 411 and 416, data fields 412 and 413, transaction state fields 413 and 418, and OS fields 414 and 419.

Referring next to FIG. 4b, a specific illustrative embodiment is of an overflow table storing transaction state information is shown. Overflow table 400 includes similar fields as discussed in reference to FIG. 4a. In contrast, entries 405, 410, and 415 include transaction read (Tr) fields 451, 456, and 461, as well as transaction write (Tw) fields 452, 457, and 462. In one embodiment, Tr fields 451, 456, and 461 and Tw fields 452, 457, and 462 are to store a state of a read bit and a write bit, respectively. In on example, the read bit and write bit to track reads and writes, respectively, to an associated cache line. Upon writing entry 405 to overflow table 400, the state of the read bit is stored in Tr field 451 and the state of the write bit is stored in Tw field 452. As a result, the state of the transaction is stored to overflow table 400 by indicating in the Tr and the Tw fields, which entries have been accessed during the pendency of a transaction.

Turning to FIG. 5, an embodiment of a multi-page overflow table is illustrated. Here, overflow table 505, which is stored in memory 500, includes multiple pages, such as page 510, 515, and 520. In one embodiment, a register in a processor stores a base address of first page 510. Upon a write to table 505, an offset, a base address, a physical address, a virtual address, or a combination thereof references a location within table 505.

Pages 510, 515, and 520 may be contiguous in overflow table 505, but are not required to be contiguous. In fact in one embodiment, pages 510, 515, and 520 are a linked list of pages. Here, a previous page, such as page 510, stores a base address of next page 515, in an entry, such as entry 511.

Initially, multiple pages in overflow table 505 may not exist. For example, when no overflow occurs, no space is potentially allocated to overflow table 505. Upon overflowing another memory, which is not shown, then page 510 is allocated to overflow table 505. Entries in page 510 are written as transactional execution continues in an overflow state.

In one embodiment, when page 510 is full, an attempted write to overflow table 505 results in a page fault, as there is no more room in page 510. Here, additional or next page 515 is allocated. The previous attempted write of an entry is completed by writing the entry to page 515. Additionally, the base address of page 515 is stored in field 511 in page 510 to form the linked list of pages for overflow table 505. Similarly, page 515 stores the base address of page 520 in field 516, when page 520 is allocated.

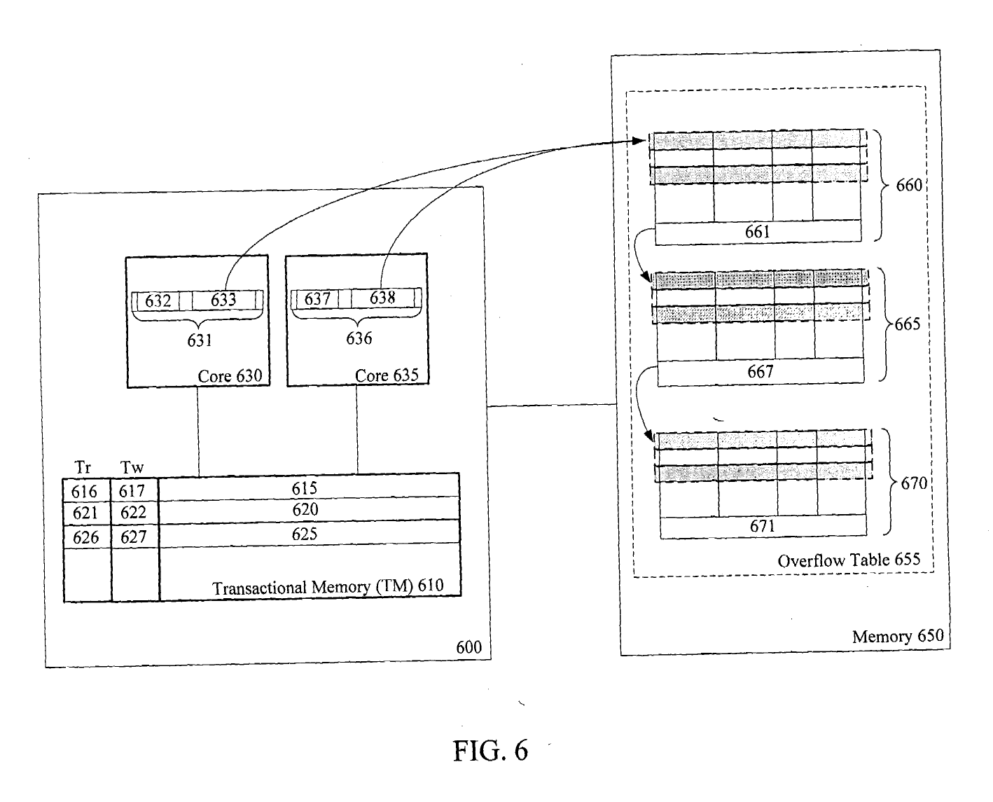

Referring next to FIG. 6, an embodiment of a system capable of virtualizing transactional memory is illustrated. Microprocessor 600 includes transactional memory 610, which is a cache memory. In one embodiment TM 610 is a first level cache in core 630, similar to the illustration of cache 103 in FIG. 1. Analogously, TM 610 may be a low level cache in core 635. In the alternative, cache 610 is higher level cache or otherwise available section of memory in processor 600. Cache 610 includes lines 615, 620, and 625. Additional fields associated with cache lines 615, 620, and 625 are transaction read (Tr) fields 616, 621, and 626 and transaction write (Tw) fields 617, 622, and 627. As an example, Tr field 616 and Tw field 617 correspond to cache line 615 and are to track accesses to cache line 615.

In one embodiment, Tr field 616 and Tw field 617 are each single bits in cache line 615. By default, Tr field 616 and Tw field 617 are set to a default value, such as a logical one. Upon a read or load from line 615 during execution of a pending transaction, Tr field 616 is set to a second value, such as a logical zero, to represent a read/load occurred during execution of a pending transaction. Correspondingly, if a write or store to line 615 occurs during a pending transaction, then Tw field 617 is set to the second value to represent a write or store occurred during execution of a pending transaction. Upon aborting or committing a transaction, all Tr fields and Tw fields associated with the transaction to be committed or aborted are reset to the default state to enable subsequent tracking of accesses to corresponding cache lines.

Microprocessor 600 also includes core 630 and core 635 to execute transactions. Core 630 includes register 631 having overflow flag 632 and base address 633. Furthermore, in the embodiment where TM 610 is in core 630, TM 610 is a first level cache or otherwise available storage area in core 630. Similarly core 635 includes overflow flag 637, base address 638, and potentially TM 610, as stated above. Although, registers 631 and 636 are illustrated as being separate registers in FIG. 6, other configurations for storing an overflow flag and base address are possible. For example, a single register on microprocessor 600 stores an overflow flag and base address, and core 630 and 635 globally view the register. Alternatively, separate registers on microprocessor 400 or cores 630 and 635 include a separate overflow register(s) and a separate base address register(s).

Initial transactional execution utilizes transactional memory 610 to execute transactions. Tracking of accesses, conflict checks, validation, and other transactional execution techniques are performed utilizing Tr and Tw fields. However, upon overflowing transaction memory 610, transaction memory 610 is extended into memory 650. As illustrated, memory 650 is a system memory either dedicated to processor 600 or shared among the system. However, memory 650 may also be memory on processor 600, such as a second level cache, as discussed above. Here, overflow table 655, which is stored in memory 650, is used to extend transactional memory 610. Extension into a higher level memory is also potentially referred to as virtualizing transactional memory or extending into virtual memory. Base addresses field 633 and 638 are to store a base address of global overflow table 655 in system memory 650. In an embodiment, where overflow table 655 is a multi-page overflow table, previous pages, such as page 660, store a next base address of a next page of overflow table 655, i.e. page 665, in a field, such as field 661. By storing next page addresses in previous pages, a linked list of pages in memory 650 is created to form multi-page overflow table 655.

To illustrate operation of an embodiment of a system to virtualize a transactional memory, the following example is discussed. A first transaction loads from line 615, loads from line 625, performs a computational operation, writes the result back to line 620, and then performs other miscellaneous operations before attempting to validate/commit. Upon the load from line 615, Tr field 616 is set to a logical value of 0 from a default logical state of 1, to represent a load from line 615 occurred during execution of the first transaction, which is still pending. Similarly, Tr field 626 is set to a logical value of 0 to represent a load from line 625. When the write to line 620 occurs, Tw field 622 is set to a logical 0 to represent a write to line 620 occurred during a pendency of the first transaction.

Now assume that a second transaction, includes an operation that misses cache line 615 and through a replacement algorithm, such as a least recently used algorithm, cache line 615 is selected for eviction while the first transaction is still pending. A cache controller or other logic, not illustrated, detects that eviction of line 615, which results in an overflow event, as Tr field 616 is set to a logical zero representing line 615 was read from during execution of the first transaction, which is still pending. In one embodiment, logic sets an overflow flag, such as overflow flag 632, based on the overflow event. In another embodiment, an interrupt is generated when cache line 615 is selected for eviction with Tr field 616 set to a logical zero. Overflow flag 632 is then set by the handler based on the handling of the interrupt. Communication protocols between core 630 and 636 are used to set overflow flag 637, so both cores are notified that an overflow event occurred and transactional memory 610 is to be virtualized.

Before evicting cache line 615, transactional memory 610 is extended into memory 650. Here, transaction state information is stored in overflow table 655. Initially, if overflow table 655 is not allocated, a page fault, interrupt, or other communication to a kernel-level program is generated to request allocation of overflow table 655. Page 660 of overflow table 655 is then allocated in memory 650. A base address of overflow table 655, i.e. page 660, is written to base address fields 633 and 638. Note as above, a base address may be written to one core, such as core 635, and through messaging protocols, the base address of overflow table 655 is written to the other base address field 633.

If page 660 of overflow table 655 is already allocated, an entry is written to page 660. In one embodiment, the entry includes a representation of a physical address associated with the element stored in line 615. It may also be said, that the physical address is also associated with cache line 615 and the operation that overflowed transaction memory 610. The entry also includes transaction state information. Here, the entry includes the current state of Tr field 616 and Tw field 617, which is a logical 0 and 1, respectively.

Other potential fields in the entry include an element field to store operand(s), instruction(s), or other information stored in cache line 615 and an operating system control field to store OS control information, such as a context identifier. An element field and/or an element size field may be optionally used based on a cache coherency state of cache line 615. For example, if cache line is in a modified state in a MESI protocol, then the element is stored in the entry. Alternatively, if the element is in an exclusive, shared, or invalid state, an element is not stored in the entry.

Assuming the write of the entry to page 660 resulted in a page fault, due to page 660 being full with entries, then a request to a kernel-level program, such as an operating system, is made for an additional page. Additional page 665 is allocated to overflow table 655. The base address of page 665 is stored in field 661 in previous page 660 to form a linked list of pages. The entry is then written to newly added page 667.

In another embodiment, other entries associated with the first transaction, such as entries based off the load from line 625 and the write to line 620, are written to overflow table 655 based on an overflow to virtualize the whole first transaction. However, copying all lines accessed by a transaction to an overflow table is not required. In fact, access tracking, validation, conflict checking, and other transactional execution techniques may be performed in both transactional memory 610 and memory 650.

For example, if the second transaction writes to the same physical memory location as the element currently stored in line 625, a conflict between the first and second transaction may be detected since Tr 626 represents the first transaction loaded from line 625. As a result an interrupt is generated and a user-handler/abort handler initiates an abort of the first or second transaction. In addition, if a third transaction is to write to the physical address, which is part of the entry in page 660, which is associated with line 615. The overflow table is used to detect a conflict between the accesses and initiate a similar interrupt/abort handler routine.

If no invalid accesses/conflicts are detected during execution of the first transaction or validation is successful, the first transaction is committed. All of the entries in overflow table 655 associated with the first transaction are freed. Here, freeing an entry includes deleting the entry from overflow table 655. Alternatively, freeing an entry includes resetting the Tr field and the Tw field in the entry. When the last entry in overflow table 655 is freed, the overflow flags 632 and 637 are reset to a default state, indicating transactional memory 610 is not currently overflowed. Overflow table 655 may optionally be de-allocated to make efficient use of memory 650.

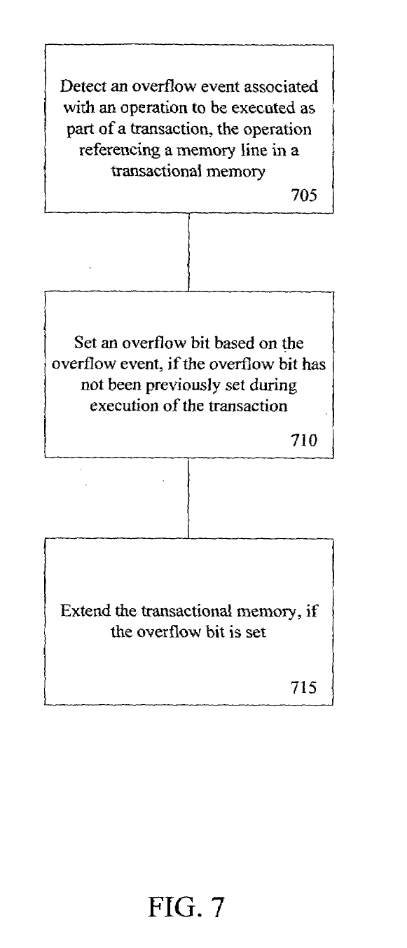

Turning to FIG. 7, an embodiment of a flow diagram for a method of virtualizing a transactional memory is illustrated. In flow 705, an overflow event associated with an operation to be executed as part of a transaction is detected. The operation references a memory line in a transactional memory. In one embodiment, the memory is a low-level data cache in one core of multiple cores on a physical processor. Here, the first core includes the transactional memory, while the other cores share access to the memory by being able to snoop for/request elements stored in the low-level cache. Alternatively, the transactional memory is a second level or higher level cache directly shared among a plurality of cores.

An address referencing a memory line includes a reference to an address that through translation, manipulation, or other computation references an address associated with the memory line. For example, the operation references a virtual memory address, that when translated, references a physical location in a system memory. Often a cache is indexed by a portion, or tag value, of an address. Therefore, a tag value of the address indexing a shared line of a cache is referenced by a virtual memory address that is translated and/or manipulated into a tag value.

In one embodiment, an overflow event includes evicting or selecting for eviction the line in the memory referenced by the operation, if the line in the memory was previously accessed by a pending transaction. Alternatively, any prediction of an overflow or event resulting in an overflow may also be considered an overflow event.

In flow 710, an overflow bit/flag is set, based on the overflow event. In one embodiment, a register to store the overflow bit/flag in a core or a processor scheduled to execute the transaction is accessed to set the overflow flag, when the memory is overflowed. A single overflow bit in a register may be globally viewed by all cores or processors, to ensure that each core is aware that the memory has overflowed and has been virtualized. Alternatively, each core or processor includes an overflow bit that is set through messaging protocols to notify each processor of the overflow and virtualization.

If the overflow bit is set, then the memory is virtualized. In one embodiment, virtualizing a memory includes saving transaction state information associated with the memory line in a global overflow table. Essentially, a representation of the line of memory that is involved in the overflow of the memory is virtualized, extended, and/or partially replicated in a higher-level memory. In one embodiment, the state of an access tracking field and a physical address associated with the line of memory referenced by the operation is stored in a global overflow table in the higher-level memory. The entries in the higher-level memory are utilized in the same manner as the memory by tracking accesses, detecting conflicts, performing transaction validation, etc.

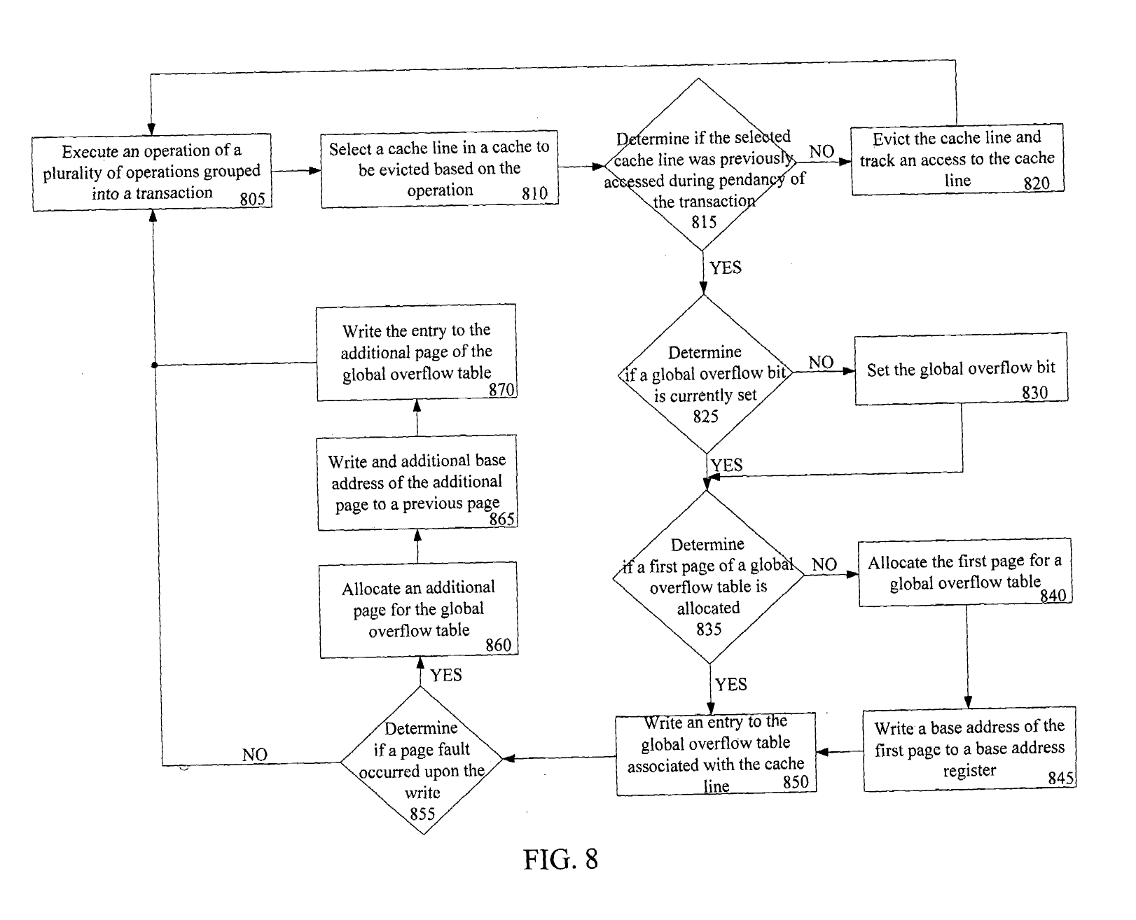

In reference to FIG. 8, an illustrative embodiment of a flow diagram for a system virtualizing transactional memory is shown. In flow 805, a transaction is executed. A transaction includes a grouping of a plurality of operations or instructions. As stated above, a transaction is demarcated in software, by hardware, or by a combination thereof. The operations often reference a virtual memory address, which when translated, references a linear and/or physical address in a system memory. A transactional memory, such as a cache, shared among processors or cores is used to track accesses, detect conflicts, perform validation, etc. during execution of the transaction. In one embodiment, each cache line corresponds to an access field, which is utilized in performing the aforementioned operations.

In flow 810, a cache line in the cache is selected to be evicted. Here, another transaction or operation attempting to access a memory location results in the selection of a cache line to be evicted. Any known or otherwise available cache replacement algorithm may be used by a cache controller or other logic to select a line for eviction.

It is then determined if the selected cache line was previously accessed during a pendency of the transaction, if decision flow 815. Here, the access tracking field is checked to determine if an access to the selected cache line occurred. If no access was tracked, then the cache line is evicted in flow 820. If the eviction was a result of an operation within a transaction, the eviction/access may be tracked. However, if an access was tracked during execution of the transaction, which is still pending, then it is determined whether a global overflow bit is currently set in flow 825.

In flow 830, if the global overflow bit is not currently set, then the global overflow bit is set, as an overflow of the cache occurred by evicting a cache line accessed during execution of a pending transaction. Note that in an alternative implementation, flow 825 may be performed before flow 815, 820, and 830, and flow 815, 820, and 830 may be skipped if the global overflow bit is currently set indicating that the cache is already overflowed. Essentially, in the alternative implementation, there is no need to detect an overflow event, as the overflow bit already represents that the cache is overflowed.

However, returning to the illustrated flow diagram, if the global overflow bit is set, then it is determined if the first page of a global overflow table is allocated in flow 835. In one embodiment, determining if the first page of a global overflow table is allocated includes communication with a kernel-level program to determine if the page is allocated. If a global overflow table is not allocated, the first page is allocated in flow 840. Here, a request to an operating system to allocate a page of memory results in the allocation of global overflow table. In another embodiment, flows 855-870, which are discussed in more detail below, are utilized to determine if a first page is allocated and allocating the first page. This embodiment includes attempting a write to a global overflow table, using a base address, which causes a page fault if the table is not allocated, and then allocating the page based on the page fault. Either way, upon allocating the initial page of the overflow table, a base address of the overflow table is written to a register in the processor/core executing the transaction. As a result, subsequent writes may reference an offset or other address, which in conjunction with the base address written to the register, references the correct physical memory location for an entry.

In flow 850, an entry associated with the cache line is written to the global overflow table. As stated above, the global overflow table potentially includes any combination of the following fields: an address; an element; a size of the cache line; transaction state information; and an operating system control field.

In flow 855, it is determined if a page fault occurred upon the write. As stated above, a page fault may be the result of no initial allocation of an overflow table or the overflow table is currently full. If the write is successful, then regular execution, validation, access tracking, commitment, aborting, etc. continues in a return to flow 805. However, if a page fault occurs indicating more space is needed in the overflow table, then an additional page is allocated for the global overflow table in flow 860. The base address of the additional page is written to a previous page in flow 870. This forms a linked-list type of multi-page table. The attempted write is then completed by writing the entry to the newly allocated additional page.

As illustrated above, the benefits of executing a transaction in hardware using local transactional memory are obtained for smaller less complex transactions. In addition, as the number of transactions being executed and the complexity of those transactions increase, the transactional memory is virtualized to support continued execution upon overflow of the locally shared transactional memory. Instead of aborting a transaction and wasting execution time, transactional execution, conflict checking, validation, and commitment is completed using a global overflow table until the transactional memory is no longer overflowed. The global overflow potentially stores physical addresses to ensure conflicts between contexts with different views of virtual memory are detected.

The embodiments of methods, software, firmware or code set forth above may be implemented via instructions or code stored on a machine-accessible or machine readable medium which are executable by a processing element. A machine-accessible/readable medium includes any mechanism that provides (i.e., stores and/or transmits) information in a form readable by a machine, such as a computer or electronic system. For example, a machine-accessible medium includes random-access memory (RAM), such as static RAM (SRAM) or dynamic RAM (DRAM); ROM; magnetic or optical storage medium; flash memory devices; electrical, optical, acoustical or other form of propagated signals (e.g., carrier waves, infrared signals, digital signals); etc.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

1. An apparatus comprising:
an execution module to execute a transaction;
a first memory coupled to the execution module, the first memory including a plurality of memory lines, wherein a memory line of the plurality of memory lines is associated with a corresponding tracking field to track accesses to the memory line during execution of the transaction; and
overflow logic to support extension of the first memory into a second memory in response to on an overflow event associated with the memory line during execution of the transaction.

2. The apparatus of claim 1, wherein the second memory is to store transaction state information from the corresponding tracking field associated with the memory line in response the overflow event.

3. The apparatus of claim 2, wherein the overflow logic comprises:
a an overflow storage element to hold an overflow value in response to the overflow event;
a base address storage element to hold a representation of a base address for a global overflow table to be stored in the second memory, wherein the global overflow table is to hold the transaction state information from the corresponding tracking field.

4. The apparatus of claim 3, wherein the corresponding tracking field to track accesses to the memory line during execution of the transaction comprises:
a first bit to track loads from the memory line during execution of the transaction;
a second bit to track stores to the memory line dig execution of the transaction.

5. The apparatus of claim 4, wherein the global overflow table to hold the transaction state information comprises:
an element field to hold an element associated with memory line in an overflow entry in the overflow table;
an address field to hold a physical address associated with the element in the overflow entry;
a transaction read state field to hold a state of the first bit of the corresponding tracking field in the overflow entry; and
a transaction write state field to hold a state of the second bit of the corresponding tracking field in the overflow entry.

6. The apparatus of claim 5, wherein the first memory is a cache memory and the second memory is a higher-level memory shared between a plurality of cores, and wherein each core of the plurality of cores checks the global overflow table for conflicts during validation, in response to the overflow storage element holding the overflow value.

7. The apparatus of claim 4, wherein an overflow event includes selecting the memory line for eviction, when either the first bit tracked a previous load from the memory line during execution of the transaction or the second bit tracked a previous store to the memory line during execution of the transaction.

8. The apparatus of claim 4, wherein an overflow event includes executing a begin transaction instruction for a second transaction that is nested within the transaction.

9. An apparatus comprising:
an execution unit to execute a plurality of operations grouped into a transaction;
a transactional memory coupled to the execution unit, the transactional memory including a plurality of lines; and
a storage element coupled to the execution unit to include an overflow field, wherein the overflow field is to hold an overflow value in response to an overflow event associated with a line of the plurality of lines to be accessed during execution of an operation of the plurality of operations grouped into the transaction.

10. The apparatus of claim 9, wherein the transaction overflow field is visible to a plurality of processing cores of a microprocessor.

11. The apparatus of claim 9, wherein one of the plurality of cores that is associated with executing the plurality of operations grouped into the transaction includes the storage element.

12. The apparatus of claim 10, wherein each of the plurality of cores, upon performing validation for the transaction, accesses a global overflow table in response to the overflow field holding the overflow value.

13. The apparatus of claim 12, wherein the overflow field is to be cleared to a non-overflowed value in response to the last entry in the global overflow table being freed.

14. The apparatus of claim 9, wherein the storage element is a machine specific register (MSR).

15. The apparatus of claim 9, wherein the overflow event associated with the line to be accessed during execution of the operation includes selecting the line, which was previously accessed during execution of the transaction, for eviction.

16. An apparatus comprising:
a processor including
an execution unit to execute a transaction;
a cache coupled to the execution unit; and
a base address register to hold a representation of a base address for a global overflow table, the global overflow table to hold transaction state information associated with the transaction in response the cache being overflowed during execution of the transaction.

17. The apparatus of claim 16, wherein the global overflow table is to hold an entry associated with a cache line of the cache overflowed during execution of the transaction, wherein the entry is to include a physical address and transaction state information associated with the cache line.

18. The apparatus of claim 17, wherein the transaction state information comprises: a state of a first bit and a state of a second bit associated with the cache line, the first bit to track reads from the cache line and the second bit to track writes to the cache line during execution of the transaction.

19. The apparatus claim 18, wherein the entry is to further include: a copy of a data element associated with the cache line, if the cache line is in a modified state.

20. The apparatus of claim 18, wherein the entry is to further include: an operating system (OS) control field.

21. The apparatus of claim 16, wherein the global overflow table is also to hold a physical address of a next page in the global overflow table.

22. An apparatus comprising:
an execution module to execute a transaction;
a memory coupled to the execution module, the memory including a plurality of blocks, wherein an access tracking field is to track accesses to a block of the plurality of blocks during execution of the transaction;
a first storage element to include an overflow field, the overflow field to be set to an overflow value upon a current access to the memory, if the block is selected to be evicted in response to the current access and the access tracking field indicates a previous access to the block during execution of the transaction; and
a second storage element to hold a base address of a global overflow table, if the overflow flag is set.

23. The apparatus of claim 22, further comprising:
logic to set a first bit of the access tracking field, in response to a load from the block during execution of the transaction;
logic to set a second bit of the access tracking field, in response to a store to the block during execution of the transaction; and
logic to clear the first and second bit upon committing the transaction, if the first bit was set during execution of the transaction.

24. The apparatus of claim 23, wherein the global overflow table is to hold an entry associated with the block, if the global overflow bit is set, wherein the entry comprises:
a physical address associated with the block;
a data element associated with the block, if the block is held in a first coherency state;and
a logic value of the first bit;
a logical value of the second bit;
an operating system (OS) control field.

25. The apparatus of claim 24, wherein the memory is a cache, and wherein the first coherency state is a modified state.

26. The apparatus of claim 22, wherein the first and second storage elements are a Machine specific register (MSR).

27. The apparatus of claim 22, wherein the first storage element is an overflow register and the second storage element is a base address register.

28. The apparatus of claim 22, wherein the overflow field includes an overflow bit, the memory is a cache memory, and the base address of the global overflow table is a physical base address in a higher level memory than the cache memory of a memory hierarchy.

29. A system comprising:
a microprocessor including
an execution unit to execute a transaction;
a transactional memory (TM) coupled to the execution unit;
overflow logic to support extension of the TM into an overflow table to be hold in a second memory in response to an overflow event that occurs during execution of the transaction; and
the a second memory at a higher level than the TM in a memory hierarchy to hold the overflow table.

30. The system of claim 29, wherein extension of the TM into the overflow table includes saving transaction state information associated with the transaction in the overflow table.

31. The system of claim 30, wherein the overflow logic comprises:
a first register to store an overflow bit to be set in response to the overflow event that occurs dug execution of the transaction;
a second register to store a physical base address of the overflow table in the second memory.

32. The system of claim 31, wherein the overflow table held in the second memory includes a plurality of pages, wherein each page of the plurality of pages is to hold a next physical base address for a next page of the overflow table.

33. The system of claim 31, wherein the TM is a cache memory and the second memory is a system memory, and wherein an overflow event includes selecting a cache line of the cache to evict that was previously accessed during execution of the transaction.

34. The system of claim 33, wherein selecting a cache line to evict is done by a cache controller, and wherein the overflow bit to be set in response to selecting the cache line to evict that was previously accessed during execution of the transaction comprises:
generating an interrupt, in response to selecting the cache line to evict that was previously accessed during execution of the transaction; and
setting the overflow bit with a handler invoked to handle the interrupt.

35. A method comprising:
detecting an overflow event associated with an operation to be executed as part of a transaction, the operation referencing a memory line in a transactional memory;
setting an overflow bit in response to the overflow event, if the overflow bit is not currently set; and
extending the transactional memory into a second memory in response to the overflow bit being set.

36. The method of claim 35, wherein extending the transactional memory into a second memory in response to the overflow bit being set comprises: storing a state of the t on in a global overflow table in response to the overflow bit being set.

37. The method of claim 35, wherein detecting an overflow event associated with an operation to be executed as part of a transaction comprises:
selecting the memory line to evict;
determining from an access tracking field associated with the memory line, if the memory line was previously accessed during execution of the transaction; and
detecting an overflow event, if the memory line is determined to have been previously accessed during execution of the transaction.

38. The method of claim 35, wherein the overflow bit is stored in a machine specific register (MSR) viewable by a plurality of cores.

39. The method of claim 36, wherein storing the state of the transaction in the global overflow table comprises:
writing an entry to the global overflow table, wherein the try includes
a physical address associated with the memory line;
a state of a first tracking field for tracking loads from the memory line during execution of the transaction;
a state of a second tacking field for tracking stores from the memory line during execution of the transaction; and
a data element associated with the physical address, if the memory line is in a modified state.

40. A method comprising;
executing an operation of a plurality of operations grouped into a transaction;
selecting a cache line in a cache to be evicted based on the operation; and
if the selected cache line was previously accessed during pendency of the transaction;
setting a global overflow bit, if the global overflow is not currently set;
allocating a first page of memory in a second memory for a global overflow table, if the first page for the global overflow table is not currently allocated, wherein the global overflow table is to store state information associated with the transaction; and
writing a base address of the first page in the system memory to a base address register, upon allocating the first page for the global overflow table.

41. The method of claim 40, further comprising:
generating an interrupt if the selected cache line was previously accessed during pendency of the transaction; and
handling the interrupt with a handler, wherein the global overflow bit is set based on the handling of the interrupt.

42. The method of claim 41, wherein state information associated with the transaction includes a state of an access tracking field to tack accesses to the cache line during pendency of the transaction.

43. The method of claim 42, wherein the global overflow table is also to store:
a physical address associated with the cache line; and
Operating System (OS) control field information.

44. The method of claim 43, wherein the OS is to allocate the first page of memory in the second memory based on the interrupt.

45. The method of claim 40, further comprising:
allocating an additional page in the second memory for the global overflow table, if an overflow page fault occurs and at least the first page is currently allocated for the global overflow table; and
writing an additional base address of the additional page in the second memory to a previous page in the second memory, the previous page logically preceding the additional page in the global overflow table.
